(19) United States
(12) Patent Application Publication
(10) Pub. No.: US 2012/0018369 A1
(43) Pub. Date: Jan. 26, 2012

(54) Wedge-wire in-port filter

(76) Inventor: Monte E. Markgraf, Yakima, WA (US)

(21) Appl. No.: 13/135,986

(22) Filed: Jul. 19, 2011

Related U.S. Application Data
(60) Provisional application No. 61/400,062, filed on Jul. 20, 2010.

(51) Int. Cl. B01D 35/28

(52) U.S. Cl. 210/435

(57) ABSTRACT

The present invention includes a retrofit, in-port filter specially configured for filtering a fluid flow at a high velocity with a minimum of flow resistance. The in-port or simply port filter, is easily retrofit into a threaded pipe connection, and employs a wedge-wire coil, which serves an efficient and self-cleaning screen to prevent the intake of small particulate into the filter, without the need for moving parts, or continuous monitoring and frequent maintenance. One end of the coil is received into a coupler, the outside diameter of the coil less than the coupler's outside diameter, so that the port filter is easily retrofit into an existing fluid distribution system, with the coil insert-able into a nipple off a pipe main. The pipe can transport any fluid, but is preferably carrying water at a moderately high velocity and pressure, such as an irrigation circle-pivot tube pipe.

This Non-Provisional Application claims priority to Provisional Patent Application Ser. No. 61/400,062, filed Jul. 20, 2010.

### TECHNICAL FIELD

The invention relates to a port filter for a high velocity fluid flow. More particularly, the port installed filter of the present invention provides a retrofit-able efficient and self-cleaning filtration of small particle contaminants, using a wedge-wire screen, with a minimum of flow resistance and without the need for moving parts or continuous monitoring and maintenance.

### BACKGROUND OF THE INVENTION

Large-scale irrigation water distribution systems, which serve a multiple of nozzles or sprinklers, demands efficient and low maintenance water filtering. Efficient filters must be strong and self-cleaning, and are especially important in water distribution systems that utilize water having a high particulate impurities, as typically found in irrigation water supplied from wells, ponds, streams or rivers. Wedge-wire types of screens are especially useful in the filtration of fluids with high quantities of suspended solids and particulates, in that these screens, especially when fabricated from stainless steel alloys, are relatively maintenance free and self cleaning.

To realize the advantages afforded by wedge-wire screens, such a screen must be configured or packaged in a way that is easily retrofit-able into existing distributions systems with a minimum of re-tooling and modifications.

The filter of the present invention addresses these shortcomings of conventional high velocity filter configurations and designs to provide a superior functioning retrofit-able filter. The aspects and advantages of the invention will become apparent from consideration of the following figures and description.

### BRIEF DESCRIPTION OF DRAWINGS

FIG. 1 is a side view of a port filter, according to an embodiment of the invention;

FIG. 2 is a first end view of a port filter, according to an embodiment of the invention;

FIG. 3 is a second end view of a port filter, according to an embodiment of the invention;

FIG. 4 is a partially sectioned side view of a port filter, along the section line 4-4 of FIG. 3, according to an embodiment of the invention; and

FIG. 5 is a partially assembled, exploded perspective view of a port filter, according to an embodiment of the invention.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and that the embodiments are sometimes illustrated by fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

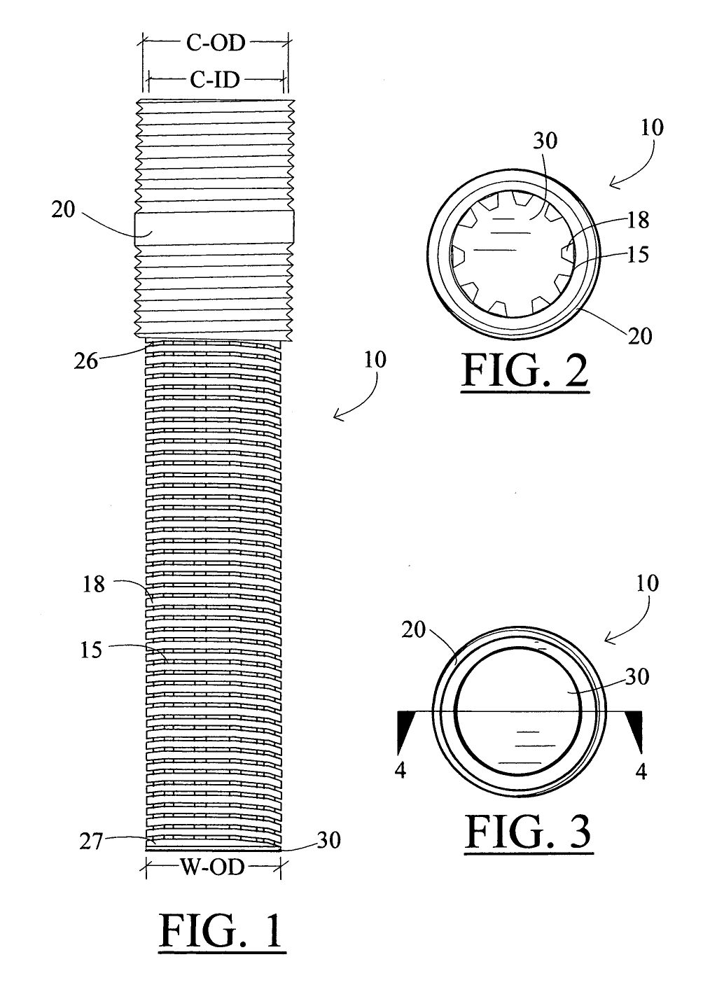

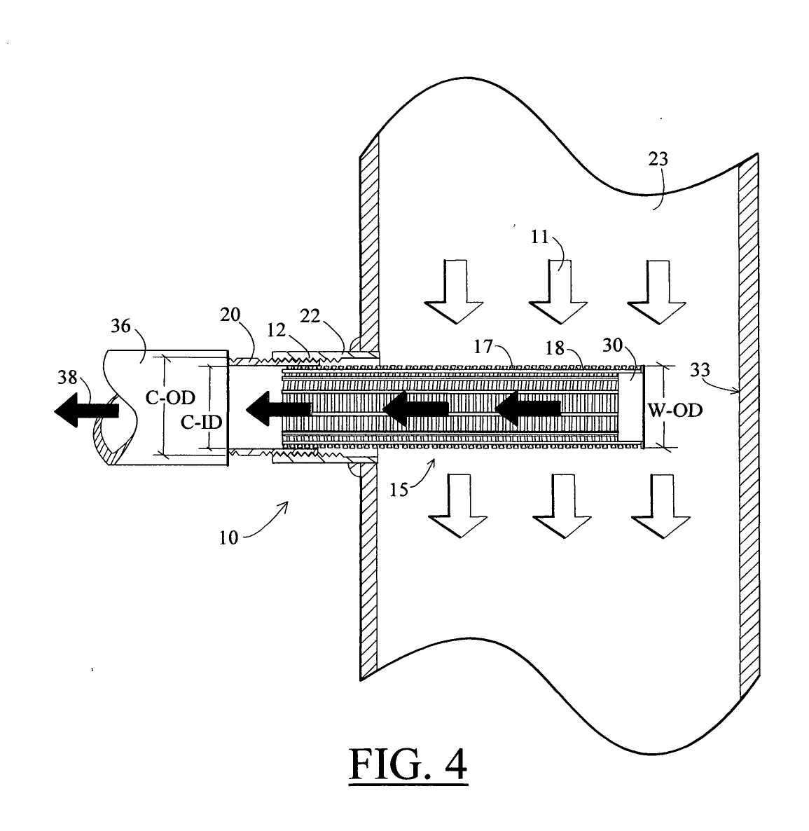

The present invention includes a retrofit, in-port filter 10, as shown in FIGS. 1 through 5. The in-port filter may also be simply referred to herein as a ‘port filter,’ in that it is preferably installed within the outlet port of a pipe. The port filter is specially configured for filtering a fluid flow 11 at a high velocity with a minimum of flow resistance. The port filter is easily retrofit and insert-able into a port, which is preferably a threaded pipe connection 12, as shown in FIG. 4. The port filter employs a wedge-wire coil 15, which serves an efficient and self-cleaning screen to prevent the intake of small particulate into the filter, without the need for moving parts, or continuous monitoring and frequent maintenance.

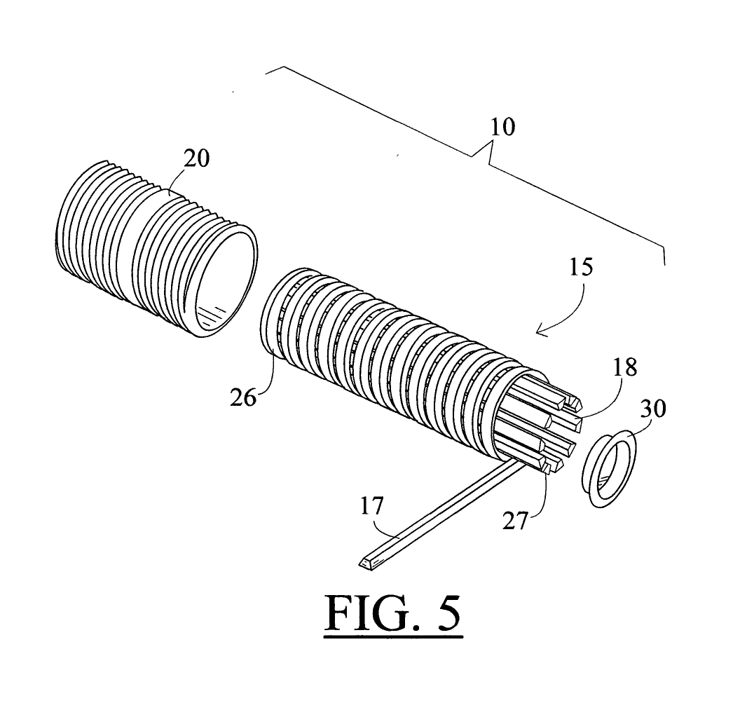

The wedge-wire coil 15 is a known fluid screening technology, and is also referred to as a ‘V-wire’ or a ‘tri-wire’ screen, as are typically utilized as a retaining media for de-watering, and solid-liquid separations. Manufactures of such screens include Industrial Screen Products, Inc. of Placerville Calif., USA, and Amistco Separation Products, Inc. of Alvin Tex., USA. The wedge-wire coil is formed as shown in the simplified perspective of FIG. 5, with an outer coil 17 wrapped around a frame 18. Both the outer coil and the frame are preferably formed of the wedge-wire material. The outer coil preferably held in place on the frame by a welded connection at each point of contact with the frame. The sizing of the wedge-wire and the gaps between any two adjacent coils and any two adjacent members of the frame are dictated by known engineering tolerances and constraints, as well-know by those persons skilled in the specification of wedge-wire sieves and filters. Factors such as flow velocity, fluid viscosity and pressure, desired pressuredrop, and the size and concentration of solid material in the fluid are all considered in the selection and specification of the wedge-wire coil.

As shown in FIG. 5, for the port filter 10 of the present invention, the wedge-wire coil is configured as a cylindrical intake screen, sized and configured to prevent the entry of particulate, such as particles that would clog or fowl downstream nozzles or sprinkler heads in an irrigation water distribution system, and ideally with a minimum of resistance to flow. The wedge-wire coil is preferably made of a ‘Type 304’ stainless steel alloy, although other alloys are considered for use, such as a ‘Type 316’ stainless, especially for use in water with high dissolved mineral content, or in saline applications.

The port filter 10 of the present invention includes a coupler 20 mounted to the wedge-wire coil 15. As shown in FIG. 1, the coupler has a coupler outside diameter C-OD, and is most preferably a male threaded pipe connector. The coupler is selected to fit within a nipple 22, branching off a pipe main 23, as shown in FIG. 4. Most preferably, the nipple is preferably internally female threaded, to receive the coupler. The coupler also has a coupler inside diameter C-ID, which is selected to receive the wedge-wire coil. The coupler is preferably fabricated from the same alloy as the wedge-wire coil, or a compatible material, and the connection of the wedge-wire coil to the coupler must be strong and secure. A welded mounting is preferred, although an industrial adhesive or mechanical fastening, such as a screw or a conventional crimping attachment are also considered. The frame 18 may be attached to the coupler, or the outer coil 17, as preferred, fully received within the coupler, as shown in FIG. 4. For the present invention, the cylindrical wedge-wire coil 15 includes a proximal end 26, opposite a distal end 27, with the proximal end of the wedge-wire coil is received into the coupler, as also shown in the section view of FIG. 4. The wedge-wire coil has a wedge-wire coil outside diameter W-OD, as shown in FIG. 1. The wedge-wire coil outside diameter must be less than the coupler outside diameter C-OD, and most preferably, approximately equal to the coupler inside diameter C-ID. This key feature provides for the ability of the port filter 10 to easily retrofit to an existing fluid distribution system, with the wedge-wire coil insert-able into the nipple 22 off the pipe main 23, and the coupler with the threaded connection to the nipple. The main pipe can be any fluid transporting pipe, but is preferably a pipe carrying fluid, such as water at a moderately high velocity and pressure, as typically encountered in an irrigation circle-pivot tube pipe.

The term “approximately” is used herein to refer to a range of values or relative orientations, understood by a person skilled in the pertinent field or skill, as being substantially equivalent to the herein stated values in achieving the desired results, a range typical to the accuracy and precision of conventional tooling, instrumentation or techniques, or a functionally equivalent range of features that produce equivalent results to those described herein.

As preferred, the port filter 10 is inserted perpendicular to the main fluid flow 11, as shown in FIG. 4. Additionally, the port filter is most preferably sized to extend across the pipe main, proximate to an opposite pipe wall 33. With the port filter extending across the main pipe and perpendicular to flow, the wedge-wire coil 15 is squarely impacted by the high velocity main fluid flow, and so is able to extract the water internally, and expel entrained particulate, with a minimal chance for fowling or clogging.

Additionally, a plug 30 is received into and firmly mounted within the distal end 27 of the wedge wire coil 15. The plug is detailed in FIG. 5, as a cap for the wedge-wire coil, that preferably mounts approximately flush to its distal end, as shown in FIG. 1. Importantly, the plug prevents the fluid flow 11 within the pipe main 33 from bypassing the wedge-wire coil. The plug can be affixed to the wedge-wire coil by any conventional means, and preferably by insetting the plug into the wedge-wire coil, as shown in FIG. 4, and expanded into place with a conventional crimping or a weld.

Again, the port filter 10 is specifically configured for retrofit insertion through a nipple 22 into a pipe main 23, with the coupler 22 attachable to the nipple, by virtue of the wedge-wire coil 15 having a wedge-wire coil outside diameter W-OD equal to or less than the coupler outside diameter C-OD. The coupler is then able to receive a branch pipe 36 as shown in FIG. 4, which receives an internal filtered flow 38 within the port filter that is then distributed as needed, preferably to a sprinkler nozzle when the port filter is employed in an irrigation system.

The port filter 10 of the present invention could be manufactured to be insert-able into any nipple 22 of any nominal diameter desired, as long as the above listed criteria are met. However, a preferred nominal size for the port filter is ¾ inch, for use in a ¾ inch nipple. Specifically, for this preferred size, the coupler outside diameter C-OD would be 1.060 inches, with a coupler inside diameter C-ID of 0.829 inches, which matches the preferred wedge-wire coil outside diameter W-OD for this nominal sizing. The wedge-wire coil 15 would preferably have an overall length, from the proximal end of the coil 26 to the distal end 27 of the wedge-wire coil, of approximately 5 inches. This overall length allows the port filter 10 to span across the inside of the pipe main 23 without contacting the opposite pipe wall 33, as shown in FIG. 4. Other most preferred nominal sizes for the port filter are insert-able into ½ inch, 1 inch, 1¼ inch, 1½ inch and 2 inch nominally sized nipples.

A preferred embodiment of the wedge-wire coil for use in a ¾ inch nominally sized nipple 22, utilizes wedge-wire for the outer coil 17 and frame 18 having a diameter of 0.063 inches, to form spaces or slots in the wedge-wire coil of approximately 0.080 inches by 0.140 inches. However, the size of the wedge-wire utilized, and the resultant spacing of the wedge-wire outer coil and internal frame can be varied as necessary for the particular application and engineering in a specific installation, as discussed above.

In compliance with the statutes, the invention has been described in language more or less specific as to structural features and use or manufacturing process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited but by the following claims, as appropriately interpreted by the doctrine of equivalents.

The following is claimed:

1. A port mounted filter comprising:
a wedge-wire coil having an outer coil wrapped around a frame, the outer coil and the frame formed of a wedge-wire material, and the wedge-wire coil including a proximal end, opposite a distal end, and the proximal end of the wedge-wire coil mounted to a coupler;
the coupler mountable to a pipe, with the wedge-wire coil extended into the pipe; and
an internal filtered flow receivable within the wedge-wire coil from the pipe.

2. The port mounted filter of claim 1, additionally comprising a plug mounted to the distal end of the wedge wire coil, the plug for preventing a bypass flow from entering the port mounted filter from the pipe.

3. The port mounted filter of claim 1, wherein the outer coil of the wedge-wire coil is held in place on the frame by a welded connection at each point of contact of the outer coil with the frame.

4. The port mounted filter of claim 1, additionally comprising a nipple mounted to the pipe, the nipple for receiving the coupler.

5. A port mounted filter comprising:
a wedge-wire coil having an outer coil and a frame, the outer coil wound about the frame in a spiral, the frame and the outer coil formed of a wedge-wire material, and the wedge-wire coil including a proximal end, opposite a distal end;
the proximal end of the wedge-wire coil mounted within a coupler;
the coupler mounted to a pipe main having the wedge-wire coil extended into the pipe main, the pipe main including an unfiltered fluid flow; and
an internal filtered fluid flow received within the wedge-wire coil from the unfiltered flow within the pipe main.

6. The port mounted filter of claim 5, additionally comprising a plug mounted to the distal end of the wedge wire coil, the plug for preventing a bypass flow from entering the port mounted filter from the pipe.

7. The port mounted filter of claim 5, wherein the outer coil of the wedge-wire coil is held in place on the frame by a welded connection at each point of contact of the outer coil with the frame.

8. The port mounted filter of claim 5, additionally comprising:
a nipple mounted to the pipe main, the nipple for receiving the coupler; and
a pipe branch mountable to the coupler, the pipe branch for receiving the internal filtered flow from the wedge wire coil.
